(19) United States
(12) Patent Application Publication
(10) Pub. No.: US 2002/0134154 A1
(43) Pub. Date: Sep. 26, 2002

(54) Method and apparatus for on-chip measurement of micro-gyro scale factors

(76) Inventors: Ying W. Hsu, Huntington Beach, CA (US); John Reeds, San Juan Capistrano, CA (US)

Correspondence Address: Daniel L. Dawes, MYERS, DAWES & ANDRAS LLP, 19900 MacArthur Boulevard, Suite 1150, Irvine, CA, 92612, US

(21) Appl. No.: 09/816,710

(22) Filed: Mar. 23, 2001

(51) Int. Cl. G01P 3/44; G01P 9/00

(52) U.S. Cl. 73/504.04; 73/504.12

(57) ABSTRACT

Rotation of an inertial mass included in the gyro is produced by applying a torque to the inertial mass about a rate axis orthogonal to the drive axis along or about which the drive motion of the inertial mass is defined. The torque is applied by created a potential difference between interdigitated finger electrodes, by a piezoelectric element or any other known or later discovered means. The combination of the drive motion and the torque produces a Coriolis force which produces a displacement of a sense element coupled to the inertial mass or a displacement of the inertial mass itself. The induced rotation about the rate axis simulates the angular momentum which would be produced in the gyro by a precision rate table. This displacement or response is then an empirical parameter which characterizes the gyro's response to a simulated rate table test and can then be used to generate a correction factor for the gyro and to thus calibrate it.

### Background of the Invention

1. Field of the Invention

The invention relates to a method and apparatus for group testing and calibration or determining the scale factor of sensors, e.g. gyroscopes or micro-gyros, without requiring the use of a rate table or more specifically mass testing and calibration or determining the scale factor of gyroscopes or micro-gyros on chip.

2. Description of the Prior Art

Gyroscopes comprise a class of angular velocity measurement sensors and include a subclass referred to as “micro-gyroscopes” or “micro-gyros” which are typically a few millimeters on a side. These micro-gyros are manufactured using conventional integrated circuit technologies, using high precision photolithography in combination with silicon, quartz, and other materials that are compatible with wafer processing techniques common in the microelectronic industry. Typical micro-gyros are described in U.S. Pat. No. 5,955,668 (1999) and U.S. Pat. No. 6,089,089 (2000) for a multi-element micro gyro, both applications of which are assigned to the same assignee as the present invention, and both of which are incorporated herein by reference.

The advantage of micro-gyros is their very low unit cost. The total cost of manufacturing of a micro-gyro primarily consists of four items: the sense element, the integrated circuit element, the packaging of the elements, and the testing of the finished unit. Among the four items, testing of the finished unit comprises the highest percentage of the total cost of a finished micro gyro unit. The testing of micro-gyros is more expensive because, unlike batch fabrication of the sensor or the IC elements, each unit must be individually tested, consuming significant labor expense. Although attempts are being made to lower the cost by testing a group of units (typically 25 to 50) together, the testing cost of a micro-gyro remains the predominant cost component.

Among the various micro-gyro tests usually performed, the measurement of the scale factor is essential to allow proper calibration of the unit. Scale factor is generally defined as the ratio of the output of the micro-gyro (where the output may be measured as current, capacitance or voltage) to the angular velocity of the unit (i.e. the micro-gyro's rate of rotation). Micro-gyro scale factors vary significantly from one unit to the next, even on the same wafer or chip. This variation is primarily due to manufacturing tolerances and temperature changes. Determination of the scale factor of a micro-gyro is necessary to calculate the appropriate correction factor needed for final calibration of a micro-gyro unit to ensure the output sensitivity is within a specified range.

A precision turntable, known as a rate table, is typically utilized to accurately measure the gyro's scale factor. A rate table provides a precise angular velocity (typically measured in deg./sec.) and allows accurate testing by mounting a single micro-gyro unit to the table on a test fixture and rotating the device at a known rate. By measuring the output of the gyro and comparing it to a known input rate from the rate table, a correction factor (gain) can be derived for biasing/adjusting the finished sensor, usually by setting the gain or other parameters in an electronic interface unit uniquely associated with the tested gyro.

While scale calibration using a rate table is common and produces acceptable result, such a method has the undesirable attribute of requiring significant labor expense. Moreover, a precision rate table not only requires a skilled operator to correctly use it, but the capital cost is high and the equipment is bulky, thereby requiring even more overhead cost to acquire, operate, house, and maintain such rate tables.

What is needed is a method or apparatus which can provide scale factor measurements at the wafer level, where a large number of devices can be tested together without needing to test the units on a rate table.

Further, what is needed is a method or apparatus which can measure the scale factors after the gyros are packaged without needing to test the units on a rate table.

### BRIEF SUMMARY OF THE INVENTION

In order to overcome the limitations of the method of scale factor testing set forth above, an inexpensive method of testing without the use of a rate table has been invented. This method of testing generally involves imparting a rotational motion into the inertial mass by applying a torque to the inertial mass about a rate axis orthogonal to the drive motion of the inertial mass. For example, an inertial mass of a micro-gyro is subject to a drive force such that it responds by moving or oscillating about the drive axis. With the use of electrodes properly placed test with respect to the inertial mass, a torque can be applied to rotate the inertial mass about an orthogonal rate axis. The combination of the drive axis oscillation, and the induced angular momentum about the rate axis results in the generation of a Coriolis acceleration about a sense axis which is orthogonal to both the drive and rate axes.

Essentially, the torque applied to the inertial mass induces an angular momentum that would otherwise be provided by a rate table. The scale factor testing of gyros on the chip can be accomplished using a periodic torque at a frequency typically much lower than the drive frequency. The waveform of the input used to generate the torque may be sinusoidal, though other periodic waveforms of similar frequency may be used. The applied torque will impart a periodic angular oscillation to the gyro about the rate axis, simulating a periodic rate input. The simulated rate input in combination with the driven oscillation will generate a Coriolis force which may be measured to determine the gyro's dynamic response.

In particular, the invention is defined as a method for measuring the scale factor of a gyro having an inertial mass, comprising the steps of driving the inertial mass in a periodic drive motion, and rotating the inertial mass about a rate axis perpendicular to the drive axis. A Coriolis force generated in response to the periodic drive motion and the rotational motion about the rate axis is then detected.

In one embodiment, the step of driving the inertial mass comprises the step of driving the inertial mass in an oscillatory linear direction along the drive axis.

In another embodiment the inertial mass is driven with an oscillatory rotational motion about the drive axis.

In both embodiments, the Coriolis force is generated in the direction of a sense axis perpendicular to both the drive and rate axes.

In one of the illustrated embodiments the step rotating the inertial mass about the rate axis perpendicular to the drive axis comprises the step of applying a voltage to at least one test electrode to rotate the inertial mass about the rate axis perpendicular to the drive axis by applying the voltage to at least one set of interdigitated fingers.

In another embodiment the step of driving the inertial mass comprises the step of rotating the inertial mass about the drive axis by means of a piezoelectric drive.

More generally, the Coriolis force generated in response to the periodic drive motion and rotational “rate” motion of the inertial mass produces a displacement of a sense element.

In the illutrated embodiments, the step of detecting the Coriolis force comprises the step of measuring the displacement of the sense element using at least one sense electrode.

In another embodiment the displacement is measured using at least one set of interdigitated fingers.

In another embodiment the Coriolis force is measured using at least one piezoelectric element.

In still another embodiment the step of detecting a Coriolis force comprises the step of measuring the displacement of the sense element optically.

In addition to measuring a displacment of a sensing element it is also within the scope of the invention to measure the displacement of the inertial mass using at least one sense electrode, such as with at least one set of interdigitated fingers.

As before the displacement of the inertial mass may be measured by using at least one piezoelectric element or by measuring the displacement of the inertial mass optically.

The invention is also an apparatus or more specifically an improvement in a microgyro for performing the above methodology.

While the method has been described for the sake of grammatical fluidity as steps, it is to be expressly understood that the claims are not to be construed as limited in any way by the construction of “means” or “steps” limitations under 35 USC 112, but to be accorded the full scope of the meaning and equivalents of the definition provided by the claims. The invention can be better visualized by turning now to the following drawings wherein like elements are referenced by like numerals.

### BRIEF DESCRIPTION OF THE DRAWINGS

FIG. 1 is a simplified top plan view of a gyro incorporating the invention in which the gyro operates in a linear, vibrational mode.

FIG. 2 is a side elevational view of the gyro of FIG. 1.

FIG. 3 is a simplified top plan view of a gyro incorporating the invention in which the gyro operates in an oscillating rotational mode.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

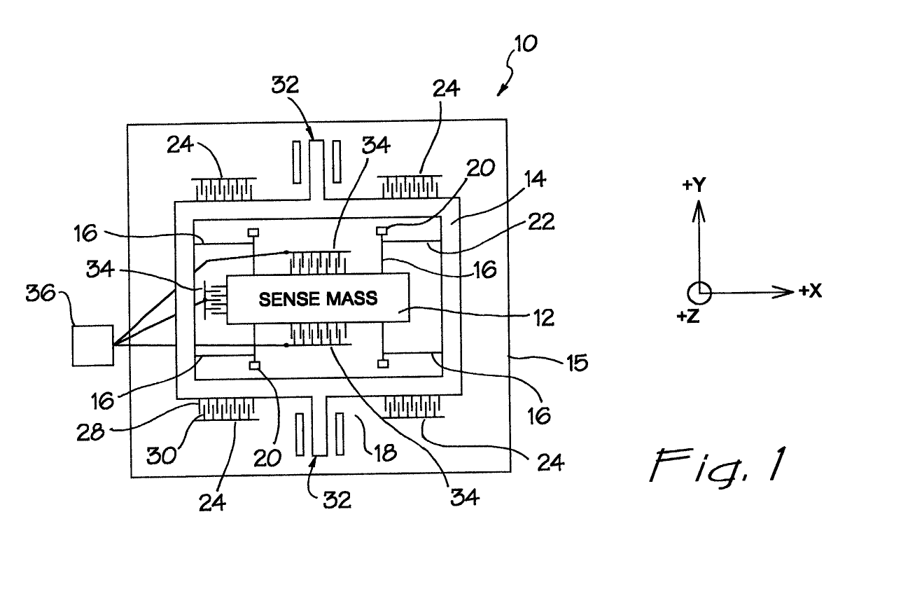

The invention is a method for measuring micro-gyro scale factors directly on the chips without requiring the use of rate tables. FIG. 1 is a simplified top plan view in enlarged scale of a micro-gyro, generally denoted by reference numeral 10. The Y axis is defined as the vertical direction in the plane of the illustration of FIG. 1 and X axis is orthogonal to the Y axis and also in the plane of the illustration of FIG. 1. The Z axis is out of the plane of the illustration of FIG. 1 and orthogonal to both the Y and X axes.

An outer inertial mass 14 functions as the driven mass of the gyro 10. The inertial mass 14 is caused to vibrate at a pre-determined frequency in the direction of the Y axis and in the plane of FIG. 1. An inner sensing element 12 functions as the sense mass of the micro-gyro. The mass of sensing element 12 is separate from its sensing function and is more a consequence of its realization by means of a material body and the need to have a sensing element with a finite resonant frequency. In theory, sensing element 12 could be nearly massless, if its resonant frequency could be held at a practical magnitude. When an angular (rate) motion about the Z axis is present, the vibration of the inertial mass along the Y axis will generate a Coriolis force, causing the sensing element 12 to vibrate in the direction of the X axis and in the plane of FIG. 1.

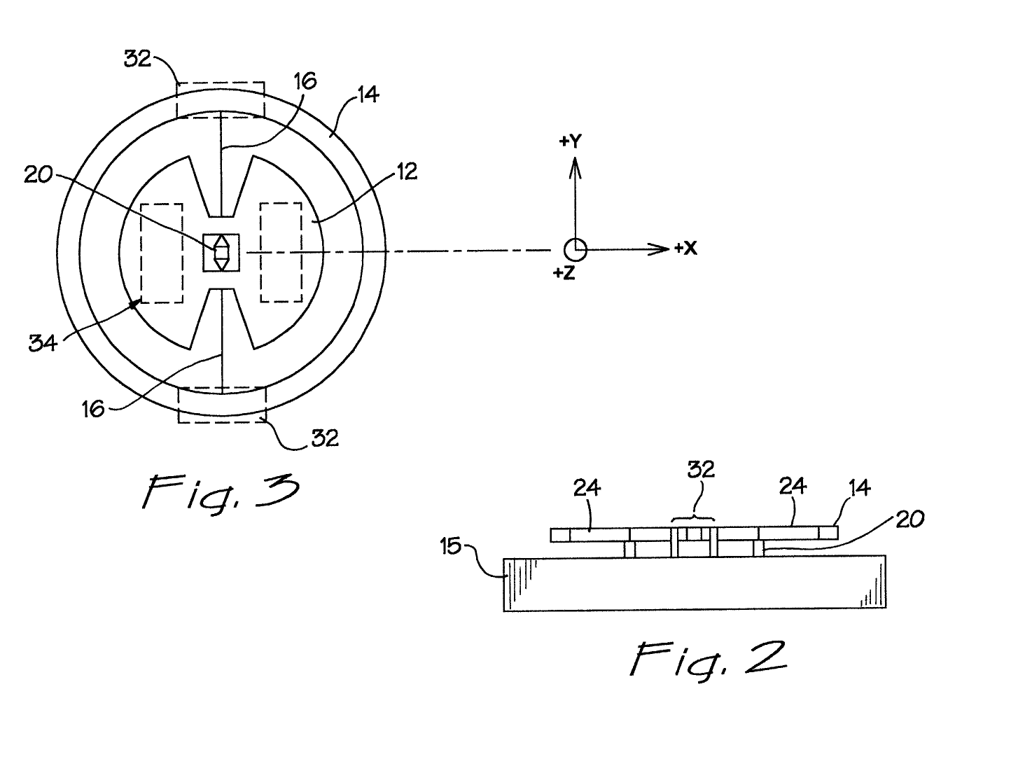

The outer inertial mass 14 and inner sensing element 12 of gyro 10 are supported on, and suspended above, a substrate 18, shown in the side elevational view of FIG. 2. Substrate 18 may be formed of any suitable material, e.g., silicon, quartz, nickel, other metals or metal alloys, ceramic. Four anchors or posts 20 are mounted on the substrate 18, and connected to the inner sensing element 12 and outer inertial mass 14. Each anchor 20 is connected to the inner sensing element 12 by a flexure or spring 16, which allows movement of sensing element 12 in the X-direction, but prevents its movement in the Y-direction. Springs 16 are very narrow (e.g., three microns) and quite long, in order not to restrict X-direction motion of sensing element 12.

Four springs 22 also support outer inertial mass 14 and transmit the Coriolis force from outer inertial mass 14 to inner sensing element 12. Each spring 22 is connected at its inner end to one of four springs 16, near the connection of that spring to its anchor 20. Springs 22 are designed to allow vibration of outer inertial mass 14 in the Y-direction, while preventing any substantial motion in the X-direction. Each spring 22 transmits the Coriolis force to the inner sensing element 12, thereby causing motion of inner sensing element 12 in the X-direction. The location of the connection between each spring 22 and its connected spring 16 is such that the Coriolis force is transmitted without compromising the independence of motion of the inner and outer masses 12 and 14. Springs 16 and 22 exert a spring force tending to return them towards their nominal positions after flexing.

Various means are available to create driving force on the outer inertial mass 14, e.g., electrostatic, magnetic, piezoelectric. In the illustrated version, electrostatic forces are used., in the form of a plurality of drive combs 24 supported on substrate 18. Each set of drive combs 24 includes electrodes 26 and 28 which form a multiplicity of interdigitated fingers or comb teeth 30 extending perpendicularly with respect to inertial mass 14. This arrangement of interdigitated fingers 30 multiplies the effectiveness of the applied voltages in creating Y-direction vibration of outer inertial mass 14. An intermediate voltage is applied to the inertial mass 14, and alternating higher and lower voltages, 180 degrees out of phase, are applied to drive combs 24 on opposing sides of inertial mass 14, in order to vibrate inertial mass 14. For example, the voltage on inertial mass 14 may be held at 6 volts, while the drive combs 24 alternate between 10 volts and 2 volts on one side of inertial mass 14, and alternate between 2 volts and 10 volts on the other side. Such voltages are supplied via terminals (not shown) supported on substrate 18, and connected both to the appropriate gyro-elements and to exterior voltage sources.

The purpose of the micro-gyro 10, i.e., measuring the angular velocity of the gyro 10 around rate axis Z, is accomplished by measuring the amplitude of the motion of the inner sensing element 12 in the X-direction. Its motion, or tendency to move, can be sensed in various ways, e.g., changes in capacitance, or piezoelectric, magnetic or optical sensing. In the illustrated preferred embodiment, a capacitor is the sensing means. When the scale factor is known, the amplitude of the sense element motion can be used to determine the angular velocity of the gyro 10 about the rate axis Z.

While the invention has been described in the context of a linearly vibrating gyro, it is to be expressly understood that the invention applies with equal validity to a rotationally vibrating gyro. The embodiment of FIG. 3 illustrates the use of the invention in a rotational mode gyro 10. Further, while a gyro 10 has been depicted in FIG. 1 with a specific geometry and topology, it is also expressly understood that the invention applies with equal validity to gyros with any geometry or topology now known or later devised.

The method of the invention as illustrated in FIG. 1 by way of example only imparts a rotational motion to inertial mass 14 . The simulated rate rotation of inertial mass 14 is accomplished by applying a torque or rotational force to inertial mass 14 about an axis orthogonal to the drive motion along the Y axis, which for example in this embodiment is the Z axis. With the use of properly placed test electrodes 32, a torque can be applied to rotate the inertial mass 14 about the Z axis, also known as the rate axis. The combination of the inertia along the Y axis, and the newly induced angular rate about the Z axis will result in the generation of a Coriolis acceleration along the X axis, which is called the sense axis. Perpendicularity between the rate axis and the drive axis is not required to generate the Coriolis force; only approximate perpendicularity is needed to obtain near optimal performance. Essentially, the applied torque induces a rotational motion that would otherwise be provided by a rate table.

Thus, a torque is applied to inertial mass 14 about the Z axis causing a Coriolis force to be generated in the direction of the X axis. The oscillation of inertial mass 14 in the direction of the X axis is limited by spring 22 so that the X axis motion transmitted to sensing element 12 through springs 16 and 22 is measured to derive the scale factor for gyro 10.

It should be noted that in order to generate a sense output, the rotational motion should be imparted while the inertial mass 14 is driven to vibrate. One of the challenges in on-chip scale factor measurement is to provide the equivalent rate rotation without significantly affecting the driven vibration or introducing undesirable motions that can be erroneously translated as sense output by a processing circuit.

The scale factor testing of gyros 10 on the chip can be accomplished using a periodic force at a frequency typically many times lower than the drive frequency of gyro 10. The waveform of the input used to generate the Coriolis force may be sinusoidal, though other periodic waveforms could also be used. The force will impart a periodic angular rotation to the gyro 10, simulating a periodic rate input. The simulated rate input in combination with the driven oscillation or vibration will generate a Coriolis force which may be measured to determine the gyro's dynamic response.

FIG. 1 illustrates a typical micro-gyro that employs a mass element driven in linear oscillation along the Y axis. Applying a voltage to the test electrode 32 creates an attractive force on one side, causing a rotation of the inertial mass 14 about the Z axis. If the applied force is periodic, for example, sinusoidal, the angular velocity of the inertial mass 14 about the Z axis, which is defined as the simulated rate, can be precisely measured. The linear velocity of inertial mass 14 in combination with the newly imposed angular velocity produces a Coriolis force along the X axis. Electrodes 34 positioned on sensing element 12 will measure the movement along the X axis, and through signal processing circuitry 36, produce an output voltage proportional to the simulated rate applied. While sensing elements 34 are shown as electrostatic interdigitated fingers or a capacitive sensor, it is also expressly contemplated that sensing elements 34 include any kind of piezoelectric or optical sensing elements now known or later devised or any other type of sensing method capable of detecting displacement or relative motion or velocity.

Sample or standard gyros of the tested design and fabrication type may be used to calibrate the test output. By comparing the output voltage measured in response to specific test voltages and a given drive amplitude to the output voltage measured using a rate table at the same drive amplitude, a correlation can be made between test voltages and angular rates. Several test points can be taken to cover the full specified range of operational rates and temperatures. Once a correlation between test voltage and equivalent rate is established, the scale factors of new gyros may be measured without the use of a rate table using the following steps:

1. Drive the inertial mass 14 into oscillation along or about a drive axis.

2. Apply a calibrated test voltage generated by a periodic oscillation circuit onto the rate test electrode 32.

3. Measure the rate output of sensing element 12 on electrodes 34.

4. Compare the measured output (scale factor) against the scale factor measured using a rate table. Determine the correction factor.

5. Store the correction factor into the memory in the interface circuitry associated with gyro 10, which interface circuitry corrects or calibrates the output of its associated gyro 10 according to the stored correction factor.

Gyros 10 can thus be each tested individually after being packaged and coupled to their corresponding interface circuits or can be tested in mass while still deployed on the wafer before connection to their corresponding interface circuits. A processor 36 then determines the correction factor for each gyro 10 on the wafer, noting its position. The appropriate correction factor is then correlated to each gyro 10 when the wafer is diced, and each gyro 10 is then packaged and/or connected to its interface circuit.

FIG. 3 illustrates the same methodology to determine the scale factor using an applied periodic voltage to create a simulated rate input on a gyro driven in a rotational mode. Inertial mass 14 is rotated about the Z axis by driving electrodes (not shown). The test electrodes 32 are then used to rotate inertial mass 14 about the X axis. Either or both of the electrodes 32 can be used to impart an angular rate about the X axis by electrostatic attraction. A resulting Coriolis torque about the Y axis will be generated, and the Coriolis force or torque is coupled by springs 16 into sensing element 12. The displacement of the sensing element 12 may be detected using sense electrodes 34 located underneath the sensing element 12.

In an alternate embodiment, the sensing element 12 may be eliminated entirely, and the Coriolis force may drive the inertial mass 14 into an oscillation about the Y axis, which may be sensed using sense electrodes located underneath the inertial mass 14. This methodology would apply to many of the existing gyro designs in which only a single mass element is used, serving as both the sensing element 12 and the inertial mass 14.

In another embodiment, many types of displacement sensing means or mechanisms might be used. The invention should not be viewed as limited to embodiments featuring capacitive sense electrodes arrangements shown. Vertical displacements between parallel interdigitated fingers or between vertically oriented parallel electrodes might also be used to detect rate output. Piezoelectric, optical, or other sensing means can also be used. The applied force generating a simulated rate can also be derived through alternative electrode arrangements (including interdigitated fingers), or by alternative methods (piezoelectric, etc. ) The same methodology can be applied to other gyro designs, or designs operating about other axes.

The invention is not limited to a specific gyro design or sense methodology. The invention is the fundamental concept of using an internally applied force to generate a simulated rate input on a gyroscopic (Dan: or “sensor”?) device to enable scale factor testing to be performed without the use of a rate table.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements than are disclosed above even when not initially claimed in such combinations.

For example, although the illustrated embodiment has only shown the invention used on gyros, it is to be expressly understood that any motion sensor can be similarly calibrated using appropriate modifications of the methodology, such as may be used in calibrating accelerometers or other displacement, velocity or acceleration sensors or transducers.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A method for measuring the scale factor of a gyro having an inertial mass, comprising the steps of:
driving said inertial mass in a periodic drive motion;
rotating said inertial mass about a rate axis perpendicular to the drive axis; and
detecting a Coriolis force generated in response to said periodic drive motion and said rotational motion about said rate axis.

2. The method of claim 1 wherein said step of driving said inertial mass comprises driving said inertial mass in an oscillatory linear direction along said drive axis and wherein said Coriolis force is generated in the direction of a sense axis perpendicular to both the drive and rate axes.

3. The method of claim 1 wherein said step of driving said inertial mass comprises the step of driving said inertial mass with an oscillatory rotational motion about said drive axis and wherein said Coriolis force is generated about a sense axis perpendicular to both the drive and rate axes.

4. The method of claim 1 where the step rotating said inertial mass about said rate axis perpendicular to said drive axis comprises the step of applying a voltage to at least one test electrode to rotate said inertial mass about said rate axis perpendicular to said drive axis, and where said resulting Coriolis force is generated about a sense axis perpendicular to both said drive and rate axes.

5. The method of claim 4 where the step of applying a voltage to at least one test electrode comprises the step of applying said voltage to at least one set of interdigitated fingers.

6. The method of claim 1 where said step of driving said inertial mass comprises the step of rotating said inertial mass about said drive axis by means of a piezoelectric drive, and where said resulting Coriolis force is generated about a sense axis perpendicular to both said drive and rate axes.

7. The method of claim 1 where said Coriolis force generated in response to said periodic drive motion and rotational motion of said inertial mass produces a displacement of a sense element, and where said step of detecting said Coriolis force comprises the step of measuring said displacement of said sense element using at least one sense electrode.

8. The method of claim 7 where said step of measuring said displacement using said sense element comprises the step of measuring said displacement using at least one set of interdigitated fingers.

9. The method of claim 1 where said Coriolis force generated in response to said drive motion and rotational motion produces a displacement of a sense element and where said step of detecting a Coriolis force comprises measuring said displacement using said at least one piezoelectric element.

10. The method of claim 1 where said Coriolis force generated in response to the drive motion and rotational motion produces a displacement of a sense element and where said step of detecting a Coriolis force comprises the step of measuring said displacement of said sense element optically.

11. The method of claim 1 where said Coriolis force generated in response to the drive motion and rotational motion produces a displacement of said inertial mass and where said step of detecting a Coriolis force comprises the step of measuring said displacement of said inertial mass using at least one sense electrode.

12. The method of claim 11 where said step of measuring said displacement of said inertial mass using at least one sense electrode comprises the step of measuring said displacement of said inertial mass with at least one set of interdigitated fingers.

13. The method of claim 1 where said Coriolis force generated in response to the drive motion and rotational motion produces a displacement of said inertial mass and where said step of detecting a Coriolis force comprises the step of measuring said displacement of said inertial mass using at least one piezoelectric element.

14. The method of claim 1 where said Coriolis force generated in response to the drive motion and rotational motion produces a displacement of said inertial mass and where said step of detecting a Coriolis force comprises the step of measuring said displacement of said inertial mass optically.

15. An improvement in a gyro having an inertial mass for measuring the scale factor of said gyro, comprising:
means for driving said inertial mass in a periodic drive motion;
means for rotating said inertial mass about a rate axis perpendicular to the drive axis; and
means for detecting a Coriolis force generated in response to said periodic drive motion and said rotational motion about said rate axis.

16. The improvement of claim 15 wherein said means for driving said inertial mass in a periodic drive motion comprises driving said inertial mass in an oscillatory linear direction along said drive axis and wherein said Coriolis force is generated along said sense axis perpendicular to both the drive and rate axes.

17. The improvement of claim 15 wherein said means for driving said inertial mass in a periodic drive motion comprises means for driving said inertial mass with an oscillatory rotational motion about said drive axis and wherein said means for rotating said inertial mass generates said Coriolis about a sense axis perpendicular to both the drive and rate axes.

18. The improvement of claim 15 where said means for rotating said inertial mass about said rate axis perpendicular to said drive axis comprises the means for applying a voltage to at least one test electrode to create a torque imparting said rotational motion to said inertial mass about said rate axis perpendicular to said drive axis, and where said resulting Coriolis force is generated about a sense axis perpendicular to both said drive and rate axes.

19. The improvement of claim 18 where said means for applying a voltage to at least one test electrode comprises means for applying said voltage to at least one set of interdigitated fingers.

20. The improvement of claim 15 where said means for driving said inertial mass in a periodic drive motion comprises a piezoelectric drive, and where said Coriolis force is generated about a sense axis perpendicular to both said drive and rate axes.

21. The improvement of claim 15 where said means for driving and said means for rotating said inertial mass produces a displacement of said means for detecting said Coriolis force.

22. The improvement of claim 21 where said means for detecting said Coriolis force comprises means for measuring said displacement using at least one sense electrode coupled to a sensing element.

23. The improvement of claim 22 where means for measuring said displacement comprises at least one set of interdigitated fingers.

24. The improvement of claim 21 where said means for detecting said Coriolis force comprises at least one piezoelectric element.

25. The improvement of claim 21 where said means for detecting said Coriolis force comprises means for measuring said displacement optically coupled to a sensing element.

26. The improvement of claim 21 where said means for detecting said Coriolis force comprises the means for measuring said displacement of s aid inertial mass using at least one sense electrode.

27. The improvement of claim 26 where said means for measuring said displacement of said inertial mass using at least one sense electrode comprises means for measuring said displacement of said inertial mass with at least one set of interdigitated fingers.

28. The improvement of claim 15 where said Coriolis force generated in response to the drive motion and rotational motion creates a displacement of said inertial mass and where the means for detecting a Coriolis force comprises the means for measuring said displacement of said inertial mass using at least one piezoelectric element.

29. The improvement of claim 15 where said Coriolis force generated in response to the drive motion and rotational motion creates a displacement of said inertial mass and where the means for detecting a Coriolis force comprises means for measuring said displacement of said inertial mass optically.
